(19) United States
(12) Patent Application Publication
(10) Pub. No.: US 2022/0005445 A1
(43) Pub. Date: Jan. 6, 2022

(54) STAFF STENCIL AND METHOD OF USE

(71) Applicant: Brittany Shoup, Easthampton, MA (US)

(72) Inventor: Brittany Shoup, Easthampton, MA (US)

(21) Appl. No.: 17/368,769

(22) Filed: Jul. 6, 2021

Related U.S. Application Data
(60) Provisional application No. 63/048,306, filed on Jul. 6, 2020.

(51) Int. Cl. G10G 7/00; B43L 7/033

(52) U.S. Cl. CPC G10G 7/00; B43L 7/033

(57) ABSTRACT

A stencil device and associated method of use for drawing, painting, etching, or otherwise marking multiple parallel lines are disclosed. The stencil may include two or more slots for drawing parallel lines, with even spacing between the lines. The stencil may also include multiple groupings of multiple slots. The stencil may be used for drawing a single musical staff, or may be configured so as to enable easy and repeatable marking of multiple musical staves. The slots may have varying widths and shapes, such as including curves, to allow for maintaining a substantially straight line even if the material of the stencil flexes or deforms during use. Various widths of slots may also be used to accommodate different marking instruments and dip diameters of different instruments.

### BACKGROUND

The present disclosure relates generally to a stencil device. More particularly, the present disclosure relates to a stencil device for aiding in creating multiple parallel lines and associated methods of use. The stencil may be configured for use in drawing, painting, etching, or otherwise using a marking instrument to create groupings of multiple lines, such as for a musical staff or multiple staves.

Many professional musicians, hobbyist musicians, music teachers, composers, conductors, and other music aficionados have a need for blank musical staffs on writing materials on which they can draw or modify musical notes. Though pre-printed musical paper is available, with staves having been created on the paper by machines, many musicians prefer to create their own staves. They can do this to be able to write music on their choice of writing/drawing media, to be able to add staves to existing sheets of music, inserting additional sections of music or otherwise editing what may already be on the paper, or simply out of a preference for or enjoyment of a hand-created sheet of music. Most commonly, hand-created staves are made through the use of a ruler or straightedge and a pencil, pen, or other writing implement. The lines on such staves tend to not be close to parallel, are not evenly spaced, and can be time-consuming to create, especially where the creator needs to put multiple staves on a single sheet of paper. Additionally, the final creation, in addition to taking a significant amount of time to make, does not tend to be aesthetically pleasing. The entire process, from time involved in drawing the staff to the final completed page, can be detrimental to the musician's creativity.

Current devices and methods of creating musical staves by hand, as well as means for creating other groupings of parallel lines by hand, are slow, tedious, and do not result in lines which are substantially parallel or evenly spaced. There is a need for a device which can quickly and easily be used to create musical staves.

### SUMMARY

The present disclosure relates generally to a stencil device. More particularly, the present disclosure relates to a stencil device for aiding in creating multiple parallel lines and associated methods of use. The stencil may be configured for use in drawing, painting, etching, or otherwise using a marking instrument to create groupings of multiple lines, such as for a musical staff or for multiple staves. The staff stencil can include a plurality of openings which can be spaced and shaped to enable controlled flexion of the material of the stencil so as to result in evenly spaced lines which are substantially parallel, straight, and which, through the use of the stencil, can be drawn, painted, etched, or otherwise marked quickly and repeatably.

The stencil may include two or more slots for drawing parallel lines, with even spacing between the lines. When configured for use in marking a musical staff, the stencil may include five or six slots per staff, though other numbers may also be used, including more or fewer slots, without deviating from the scope or intent of this disclosure. The stencil may also include multiple groupings of multiple slots, such as for marking multiple staves without having to move the stencil. This can make the marking of staves quicker and easier to do, while also allowing for not only even spacing between any given pair of lines in a staff, but also even spacing between multiple entire staves and substantially parallel lines throughout.

The slots may have varying widths and shapes, such as including curves or complex curves or other shapes, bends, or angles, or substantially straight sections, to allow for maintaining a substantially straight line even if the material of the stencil or a portion of the stencil flexes or deforms during use. Various widths of slots may also be used to accommodate different marking instruments and dip diameters of different instruments.

The stencil may have a top side and a bottom side, which may be substantially planar, or may have one or more proud features. The stencil may have at least one slot extending from the top side through to the bottom side, as well as a second slot extending from the top side through to the bottom side. The stencil may only have two slots, or it may have a larger number of slots, such as three, four, five, six, seven, or more. The first slot and the second slot may be separated by a stencil segment, which may extend the full length of the first or second slot, or just part of the length. Each slot may be sized to receive at least part of a tip of a marking instrument, such as a pen or pencil.

The stencil segment may have a width, such as at a left end of the stencil segment, which may be different from the width of the stencil segment along the length of the stencil segment. The width of the stencil segment may increase along its length, or it may increase and then again decrease back to the original width when it reaches the opposite end of the stencil segment.

Where the width of the stencil segment increases, there may be a bulge feature which may extend at least partially into the first slot, relative to a midline passing through the stencil segment. There may also be at least one other bulge feature, such as on an opposing side of the stencil segment, such as extending at least partially into the second slot. One or both bulge features may take various forms, such as being a curved surface, such as a hump, or other shapes, such as an angled, triangular element. The bulge feature may also extend into the one slot or the other, and then plateau, being substantially parallel to the midline of the stencil segment, and then extend back down towards the midline of the stencil segment.

In embodiments where the stencil segment has a bulge feature extending into the first slot and a bulge feature extending into the second slot, the two bulge features may be substantially at the same position or distance along the length of the stencil segment. In other embodiments, the bulge features may be located in different positions along the length of the stencil segment. The one or more bulge features may be located substantially at or near the middle of the length of the stencil segment, or may be offset from the middle of the length, such as towards one end or the other of the stencil segment.

At least a portion of the stencil segment may be made of a material which is elastically flexible at at least the thinnest portion of the stencil segment, or the entire stencil may be made of such a material. The stencil segment or the entire stencil may be made of plastic, metal, wood, wood composite, resin, hybrid materials, or other materials known in the art. The thickness of the material if the stencil may vary. Some exemplary thicknesses include 1.0 mm, 1.5 mm, 1.7 mm and 2.0 mm including smaller ones, larger ones, intermediated ones without deviating from the scope or the intent of this disclosure.

When the stencil segment is flexed such that the bulge feature is moved towards the midline and is in line with the side of the stencil segment where it is at its smallest width, an opposing side of the stencil segment, such as an opposing bulge, may be in contact with a side of that opposing bulge's slot. In some embodiments, the opposing bulge will contact a flat surface on the opposite side of the second slot, while in some other embodiments the opposing bulge will contact a third bulge which is on the opposing side of the second slot.

When a marking instrument is inserted into the first slot, and passed along the slot from one end of the slot to the other end of the slot, it may cause the stencil segment to flex, such as when it is in contact with the bulge feature. The bulge feature may cause at least a portion of the stencil segment to flex away from the marking instrument, enabling the marking instrument to mark a straight or substantially straight line beneath the stencil.

In some embodiments, there may be a grouping of slots, such that a passing a marking instrument through the second slot will cause the first stencil segment to flex away from the marking instrument, such as upwards away from it, while it will also cause a second stencil segment below the marking instrument, relative to the first slot, to flex away and downward towards a third slot.

Groupings of slots may come in various quantities, such as four slots, five slots, six slots, or seven slots, though greater or lesser quantities may also be present. When lines are drawn or otherwise marked through a grouping of slots, the resultant lines may be parallel to each other and at equal spacings, creating a series of parallel lines such as a musical staff. There may also be multiple groupings of slots, or slot sets, enabling a user to mark multiple groups of parallel lines, or multiple musical staves. The multiple groupings may all be of the same length, or of the same size slots, or of the same size stencil segments, or combinations thereof. Different groupings of slots may also have different lengths, different size slots, or different size stencil segments, or combinations thereof. A user may mark multiple staves on a single piece of material using the stencil by using multiple groupings of slots, or the user may use a desirably sized grouping of slots where a staff is desired, and then move the stencil to a different location on the material to mark an additional staff or additional staves, if desired.

It is to be understood that the above-mentioned steps and features and the steps and features yet to be explained hereinafter can be used not only in the respectively mentioned combinations but also in other combinations or alone without departing from the intent or context of the present invention.

### BRIEF DESCRIPTION OF THE DRAWINGS

The invention is now disclosed in detail with reference to exemplary embodiments shown in the accompanying drawings, where:

FIG. 1 shows a top view of an embodiment of the stencil of the present disclosure;

FIG. 2 shows a top isometric view of an embodiment of the stencil of the present disclosure at a first step of use, including a drawing implement and a user's hand;

FIG. 3 shows a top isometric view of the embodiment of the stencil of FIG. 2 at a later step of use;

FIG. 4 shows a top view of the markings remaining after use of the embodiment of the stencil of FIG. 2;

FIG. 5 shows a top view of three embodiments of the stencil of the present disclosure, with different stability segment widths;

FIG. 6 shows a top view of three alternate embodiments of the stencil of the present disclosure, with different slot widths;

FIG. 7 shows a top view of an embodiment of the stencil of the present disclosure showing the difference between the minimum width and the maximum width of stability segments;

FIG. 8 shows a top view of another embodiment of the stencil of the present disclosure, with varying shapes and sizes of bulges of stability segments;

FIG. 9 shows a top view of an alternate embodiment of the stencil of the present disclosure, with varying shapes and sizes of bulges of stability segments;

FIG. 10 shows a top view of an embodiment of the stencil of the present disclosure, highlighting the straightness of the top and bottom slots;

FIG. 11 shows a top view of another embodiment of the stencil of the present disclosure, with two groupings of slots;

FIG. 12 shows a top view an embodiment of the stencil of the present disclosure, showing two different lengths of slots;

FIG. 13 shows a top view of another embodiment of the stencil of the present disclosure, showing three different groupings of slots;

FIG. 14 shows a top view of an alternate embodiment of the stencil of the present disclosure, with a plurality of groupings of slots for creating a plurality of staves;

FIG. 15 shows a top view of an embodiment of the stencil of the present disclosure, highlighting different borders of the stencil; and

FIG. 16 shows a sectional view of an embodiment of the stencil of the present disclosure, highlighting differently shaped slot edges.

### DETAILED DESCRIPTION

Exemplary embodiments of the disclosure are illustrated in the Figures and are explained in the following description in more detail, wherein identical reference numbers refer to identical, or similar, or functionally identical or similar components.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials, steps, and configurations are set forth in order to provide a thorough understanding of the illustrative embodiments. However, it will be apparent to one skilled in the art that the present invention may be practiced without the specific details. In other instances, well-known features or those previously described are omitted or simplified in order not to obscure the illustrative embodiments.

Various operations may be described as multiple discrete operations, in turn, in a manner that is most helpful in understanding the present invention, however the order of description should not be construed as to imply that these operations are necessarily order dependent. In particular, these operations need not be performed in the order of presentation. In some instances, structures and devices may be shown in block diagram or flow chart form in order to facilitate describing the disclosed subject matter.

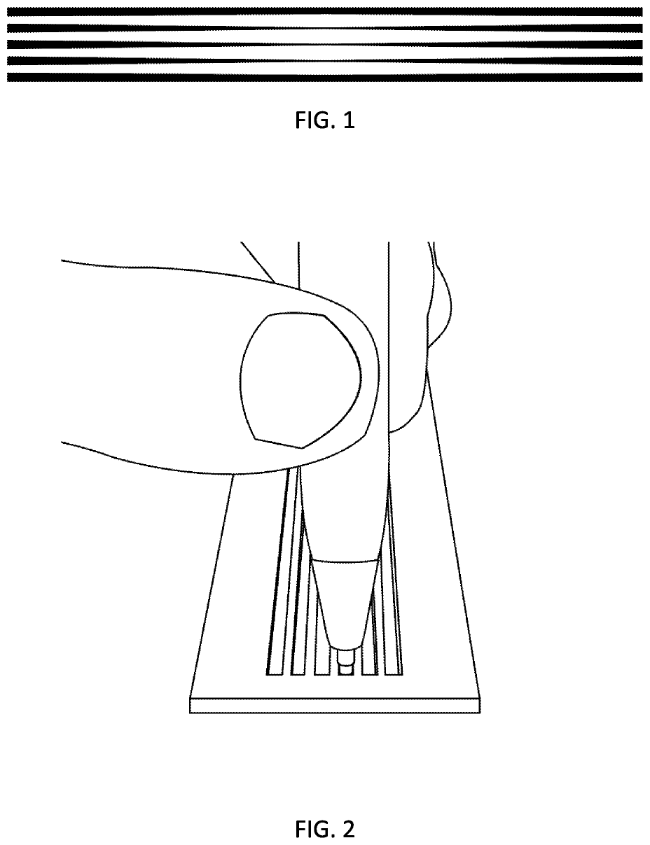

An embodiment of the stencil of the present disclosure is shown in FIG. 1. The stencil may be made of any suitable material, such as metal, plastic, wood, resin, hybrid material of combinations of multiple materials. In some embodiments, the stencil is made of one or more materials which are selected so as to enable flexion at desired thicknesses of the stencil and with desired flexural features or elements, such as stability segments. When using a single material, thicknesses of portions of the stencil may be selected so as to allow for controlled flexion where desired, and so as to resist flexion where flexion may not be desirable, such as near the top or bottom of a grouping of slots. Where combinations of materials are used, more rigid materials may be used where flexion is not desirable, while more flexible materials may be used where controlled flexion is desirable.

In the embodiment shown, the stencil is substantially rectangular, though it should be understood that other shapes, such as circular, triangular, pentagonal, hexagonal, octagonal, and various hybrid shapes, may also be used without deviating from the scope or intent of this disclosure. The stencil may also optionally include features to aid in holding the stencil during use, such as taps, extensions, or other protrusions. The bottom of the stencil may be substantially planar, so as to rest on a flat surface, such as a sheet of paper or a book, or may include elevated areas or features, such as to avoid smudging drawn lines. The top of the stencil may also be substantially planar, or may include features to aid in holding the stencil in place or in guiding larger portions of a writing or marking tool. The stencil may also optionally include alignment features, such as a ridge or other protrusion which may be used to align the stencil along a top, bottom, or side of the material or surface to be marked.

The stencil may include two or more slots, shown here and in the accompanying figures in solid black lines for clarity. The slots may be configured to receive a writing or marking tool, such as a pencil, pen, or other marking implements known in the art. The slots may be configured to a specific size of marking tool, or may be configured to receive a range of sizes. In some embodiments, the slots are sized to receive only the tip of the marking tool, enabling a user to select from a range of marking implements which may have different diameters or other sizings along the length of the implement, but generally have specific sizings of the tips of the implements. Different stencils may be used for different marking implement tip sizes, or a single stencil may include a plurality of groupings of slots with different slot widths in different groupings.

The slots may extend from near one side of the stencil to near the other side, leaving a left side margin and a right side margin. There may also be a top margin and a bottom margin. The sizing of the margins may be varied to allow for different stencils for different desired margins, or a stencil may include multiple groups of slots with different margins. It should be understood that one or more slots may extend all the way to an end of the stencil, such as to the right side, without deviating from the scope or intent of this disclosure.

Each pair of slots may be separated by a stability segment. The stability segment may be configured so as to allow for no flexion or very little flexion, or may be configured to enable controlled flexion during use. In the embodiment shown, the stability segments include a bulge which is shown as curved. As a marking tool is drawn along from one end of a slot to the other end of the slot, contact between the marking tip of the marking tool and the bulge causes the stability segment to flex away from the tool. As the bulge of one stability segment comes into contact with a second stability segment, as it deflects into that second stability segment, motion and flexion of the first stability segment are resisted by the second stability segment. Where there are further additional slots and further additional stability segments on a stencil, the resistance to flexion of the first stability segment may further increase with deflection toward and contact with each subsequent stability segment. It should be understood, however, that the stability segments may be configured so as to offer adequate resistance against deflection when the first stability segment comes into contact with the second stability segment without deviating from the scope or intent of this disclosure.

It is desirable to have a marking implement mark a substantially straight line when using the stencil. Where a plurality of lines are being marked, it is further desirable to have each of these lines be both straight and parallel to other lines. As the marking tool is drawn along a flexible stability segment, flexibility of the segment may lead to lines not being created straight. Through the use of the stencil of the present disclosure, the bulge restricts the flexion of the stability segment, enabling the marking of a substantially straight line.

The stability segment may include a first, minimum width, and a second, maximum width. The width of the stability segment may vary along the length of the stability segment. This variance may be linear, may be parabolic, may be exponential, or may be of any form which may be desirable to a user or to meet the needs of the selected material of the stencil. The stability segment may have a substantially curved profile, may have one or more substantially linear profiles, or may be a hybrid shape. As shown in figure one, the bulge is substantially curved, but other embodiments may include one or more linear portions at the beginning, end, both the beginning and the end, along the middle portion, or a combination thereof. The bulge may also be formed of angled linear features or other compound shapes. Some exemplary stability segment minimum widths include 0.5 mm, 0.7 mm, 0.8 mm, 0.9 mm, 1.0 mm, 1.1 mm, 1.2 mm, 1.3 mm, and 1.4 mm, though other minimum widths may also be included, including smaller ones, larger ones, or intermediate ones, without deviating from the scope or intent of this disclosure.

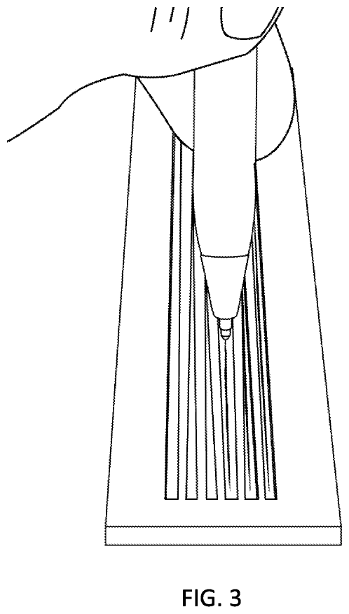

Two different moments in the use of an embodiment of the stencil are shows in FIGS. 2 and 3. A user may place the stencil on a sheet of paper or on another surface which is to be marked. The user may insert a marking implement, such as a pencil or a pen, at least partially into one of the slots. As shown, a writing tool is being used where only the tip fits into the slot. The user may insert the tip into one end of a slot, and then move the writing tool along some or all of the length of the slot. As the writing tool moves along the slot and encounters one or more bulges of one or more stability segments, the stability segments flex away from the writing tool to a limited degree, such as to the limit of the materials flexion, to the point where the bulge of one stability segment comes into contact with another stability segment, or until a plurality of stability segments have come into contact with each other. This results in the creating of a substantially straight line being drawn along the length of the slot.

It should be understood that the stencil may be configured so that flexion of any given stability segment is restricted sufficiently to allow for the marking of a straight line when a bulge of a first stability segment comes into contact with a second stability segment. However, it should also be understood that multiple stability segments may be configured to flex when a marking tool is passed along a slot, or all stability segments may flex until the margin of the stencil is contacted by a stability segment. The sizes or shapes of bulges on different stability segments may be varied so as to enable the preferred amount of flexion.

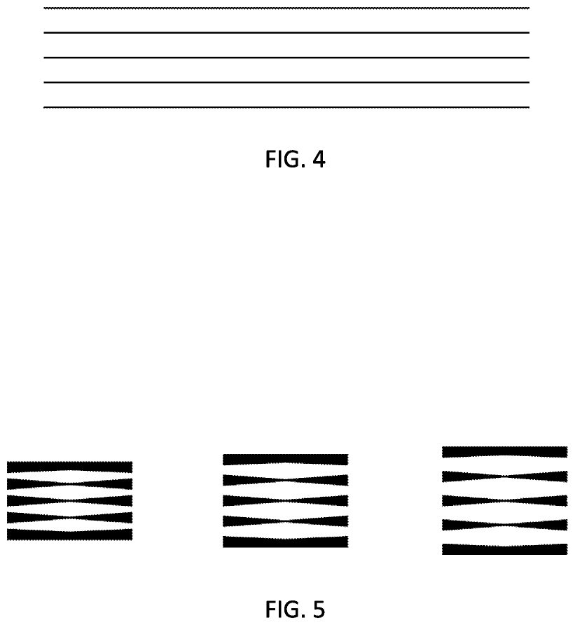

FIG. 4 shows a top view of the markings remaining after use of one embodiment of the stencil. Though the slots of the stencil themselves are not straight lines, such as where there are one or more bulges along one or more stability segments, the lines resulting from the use of the stencil are substantially straight, parallel to each other, and evenly spaced relative to neighboring lines when an embodiment of the stencil is used with evenly spaced slots.

Three different embodiments of stencils with varied stability segments are shown in FIG. 5. Each slot, as shown, has the same minimum width, allowing for a marking tool with the same size tip to be used on each stencil and resulting in marked lines which are of the same thickness. The stability segments, however, have different thicknesses, both at the stability segment minimum width and at the stability segment maximum width at the maximum points of the bulges. Different resistance forces to flexion of the stability segments can be created through the use of different stability segment widths while still allowing for the same thickness of a stencil and the same material selection. Alternatively, different materials may be used or stencils of different thicknesses may be made while maintaining the same or similar resistance to flexion of a stability segment by varying the thicknesses of the stability segments.

It may be desirable to have different spacings of resultant lines from the use of different embodiments of the stencil. Different thicknesses of stability segments may be used to provided varying spacings of marked lines, such as where a staff may be drawn larger, or where larger spacings may be beneficial for marking larger or more clearly defined notes or groupings of notes. Wider spaced lines may be used for those with poor sight or in scenarios where a staff may be used to teach music to someone who is less familiar with reading music, or for scenarios where staves of music must be read from a greater distance, such as during performances of music.

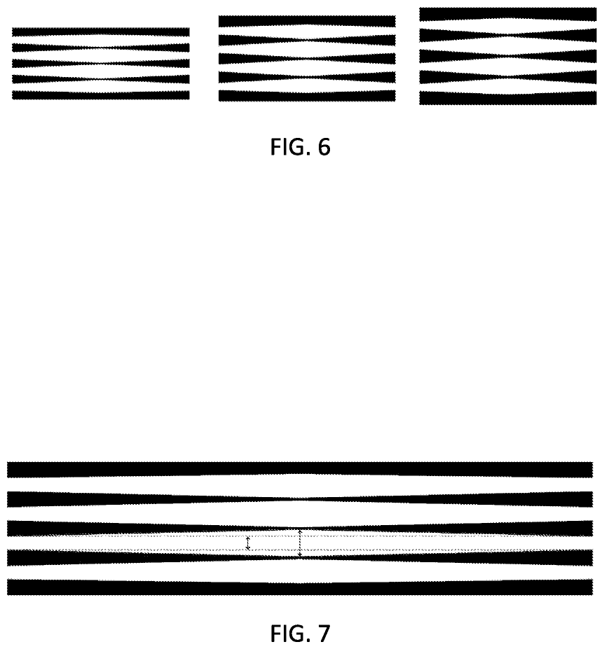

Three alternate embodiments of stencils of the present disclosure are shown in FIG. 6, wherein the slot widths are varied but the stability segments remain similar across all three embodiments. By varying the slot widths of different stencils, a user may select a stencil with slot widths which conform to the tip diameter of the marking tool which the user prefers to use or otherwise has available for use. A marking tool with a larger tip diameter would require a wider slot for use of the stencil, regardless of the actual marked line thickness. Some pens have the same tip diameter but are available in versions with different marked line thicknesses. Similarly, some marking tools, such as pens, may have standard tip diameters, while others may mark a standard thickness line but have different tip diameters across different brands. It should be understood that, in some embodiments, a single stencil may include multiple groupings of lines, with each grouping corresponding to a single staff to be marked, but may have each grouping having a different slot width. In such embodiments, a single large stencil could accommodate the usage of multiple different marking tools with different tip diameters.

As can be seen in the embodiments shown, the bulge may be a curve, as previously described, or may be formed of a substantially linear segment angled away from the midline of the stability segment, and/or a substantially linear segment angled back towards the midline of the stability segment. The transition near the apex of the stability segment bulge may be pointed, may be curved, or may include a linear segment substantially parallel to the midline of the stability segment. The edges of the slots may also be any of a number of compound shapes.

As shown in FIG. 7, a stability segment includes a minimum width, such as the width at either of the two ends of the stability segment where it contacts a side margin of the stencil. A stability segment may also include a maximum width, as shown here optionally located at the center of the stability segment. The maximum width of the stability segment may be larger than the minimum width of the stability segment, and may be configured to at least partially contact a top margin, a bottom margin, or an adjacent stability segment at the bulge during use, thus resisting flexion of the stability segment beyond a desired amount. In some embodiments, the stencil is configured so that, at maximum flexion, the bottom or top of a stability segment, at the bulge, is in line width the associated top or bottom line defining the minimum width of the stability segment.

Various sizes, shapes, and locations of bulges along one or more stability segments may be used. As shown in FIG. 8, the maximum width of the stability segment may be varied, as seen when comparing the top stability segment to the one immediately below it. Both stability segments have the same minimum width, but have different maximum widths through varying the bulge, thus allowing for differing amounts of flexion of the stability segment by varying how much flexion may be applied before flexion is resisted by an adjacent margin or adjacent stability segment.

The shape of a bulge may also be varied, also resulting in different types of lines or differing degrees of flexion, as well as resulting in different line quality. As shown with the stability segment that is third from the top, a stability segment may include one or more curved edges and may also optionally include a substantially linear edge. In the embodiment shown, the stability segment has a first curved edge along the left portion of the stability segment and a second curved edge along the right portion of the stability segment. There is a substantially linear edge, which may be substantially parallel to the midline of the stability segment, at the transition between the two curved edges. Such a transition may enable lines to be marked through the adjacent slot without showing an abrupt transition point corresponding to the maximum width of the stability segment bulge.

The location of a bulge may also be varied, as shown in the bottom stability segment, without deviating from the scope or intent of this disclosure. Though most embodiments of the stencil shown herein depict the bulge as being located substantially centrally along the length of the stability segments, the bulge may be located closer to one end or the other end of the stability segment. There may also be more than one bulge to any given stability segment, such as having one along the first half of the length of a stability segment, and having a second bulge along the second half of the length of a stability segment. Depending on the materials being used for the stencil, as well as the intended marking tools to be used by a user, different locations of bulges or different numbers of bulges may be desirable.

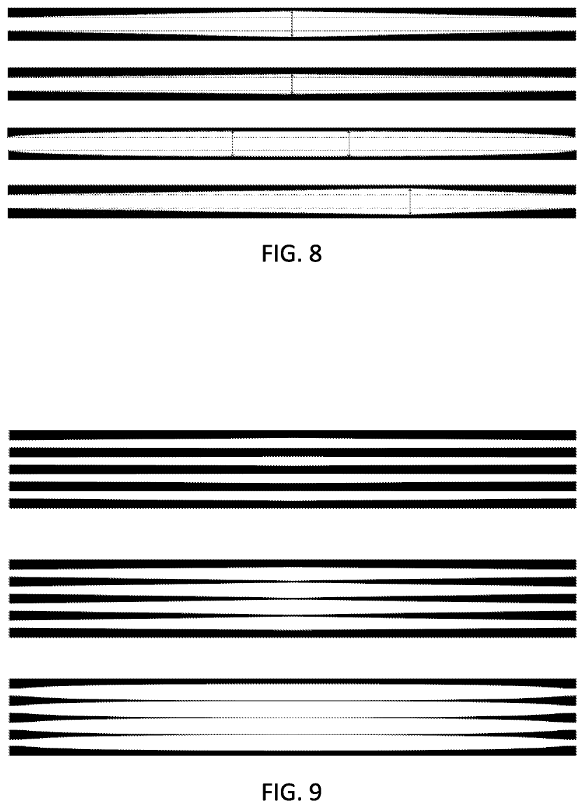

Various sizes and thicknesses of stability segments and associated bulges are shown in FIG. 9. As shown, the minimum thickness of each stability segment is the same. The maximum thicknesses may be varied, resulting in different shapes and thickness of stability segments. The shape may also be varied, such as where comparing the bottom groupings stability segments to those of the top grouping. In the top grouping, the edge of each stability segment gradually increases until reaching a maximum thickness of the bulge. In the bottom grouping, the edge of each stability segment increases quickly, resulting in more of each stability segment being at or close to the maximum thickness of the stability segment. By varying the size, shape, and thickness of a stability segment, different amounts of flexion or flexural forces may be accommodated, different thicknesses of stencils may be used, and different materials or combinations of materials may be used in manufacturing or assembling a stencil.

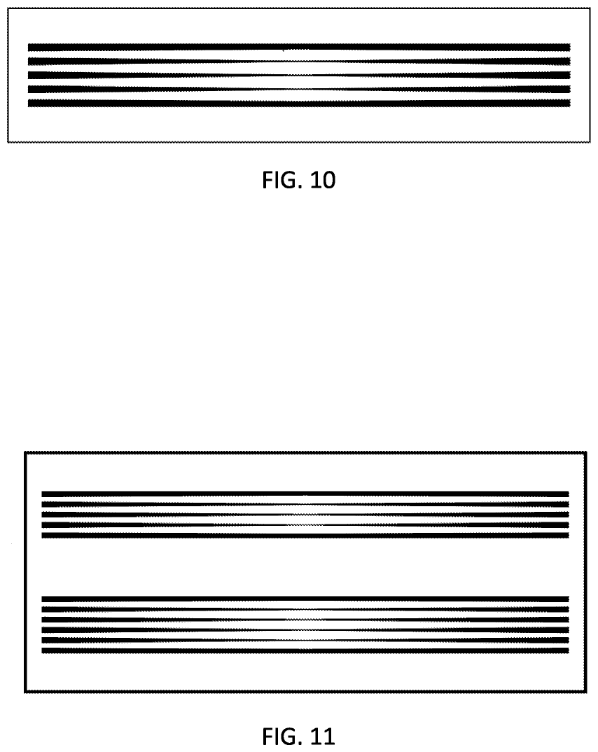

As can be seen in FIG. 10, the top edge of the top slot and the bottom edge of the bottom slot may be substantially linear and may optionally not include a bulge. A bulge may be beneficial to a stability segment where flexion of the stability segment away from a marking tool during marking may enable the marking of a straight line. However, along the top and bottom of any given grouping of lines, such as at a top margin or a bottom margin, the margin itself may provide sufficient stability to not require a bulge. Further, a bulge at a margin, such as at the bottom of a bottom slot of a grouping or at the top of a top slot of a grouping, could actually result in a marked line not being straight, but curved or otherwise shaped in conformity with the bulge. In embodiments of the stencil where the top or bottom margin are not sufficiently wide enough to have sufficient rigidity to resit flexion of the top or bottom margin, at least one bulge may be included along the top margin, bottom margin, or both the top and bottom margin, so as to maintain substantial straightness of a marked line at the top or bottom of a grouping of lines.

As previously discussed, a stencil may include more than one grouping of slots. In the embodiment shown in FIG. 11, the stencil includes two groupings of slots, such as for marking two staves. The slots and their associated stability segments may be substantially the same, such as for allowing for marking two staves without having to move the stencil, or may differ. In some embodiments, the groupings may each have a different slot width, such as for using two different tip diameter marking tools, or may have different stability segments, such as for having different line spacings. In the embodiment shown, the top grouping has five slots, while the bottom grouping has six slots, enabling a user to easily and quickly mark staves with the user's preference on numbers of lines.

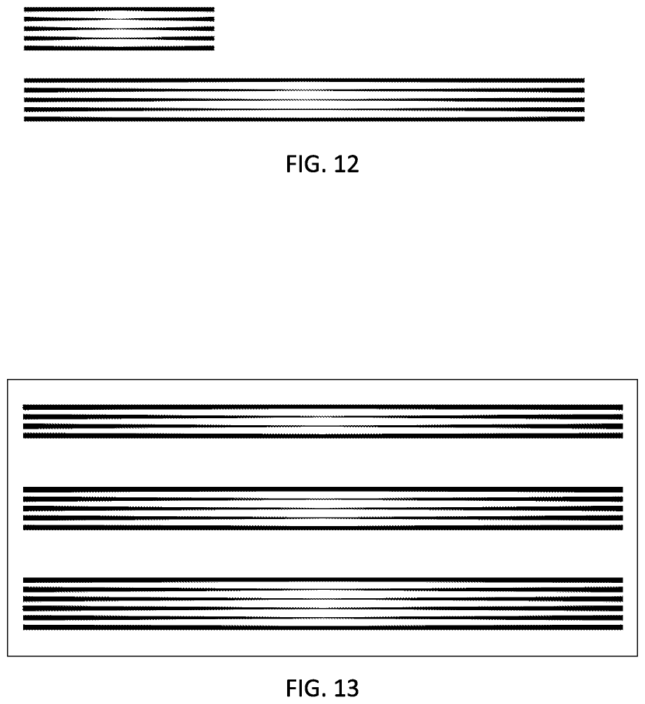

Slots and their associated stability segments may have different lengths. It may be preferable to have different stencils with different lengths of slots or, as shown in FIG. 12, a single stencil with different groupings of slots with different lengths. A user may be marking staves on different size pieces of paper or other material, or may wish to mark shorter lines or longer lines, such as for being able to add in full-length staves when needing to mark a full line of music, while also being able to mark shorter ones, such as for adding in a shorter section of music. By having slots of different lengths, the stencil may enable a user to mark different size staves while having all of the lines within a given stave be of equal length.

A stencil may include a range of numbers of slots within a given grouping, and may also optionally have multiple groupings of slots with different quantities of slots in different groupings. In the embodiment shown in FIG. 13, a stencil includes a grouping of four slots, a grouping of five slots, and a grouping of six slots, enabling easy marking of a four-line stave, a five-line stave, and a six-line stave, respectively. The slots and/or their associated stability segments may be the same or may be varied in different groupings.

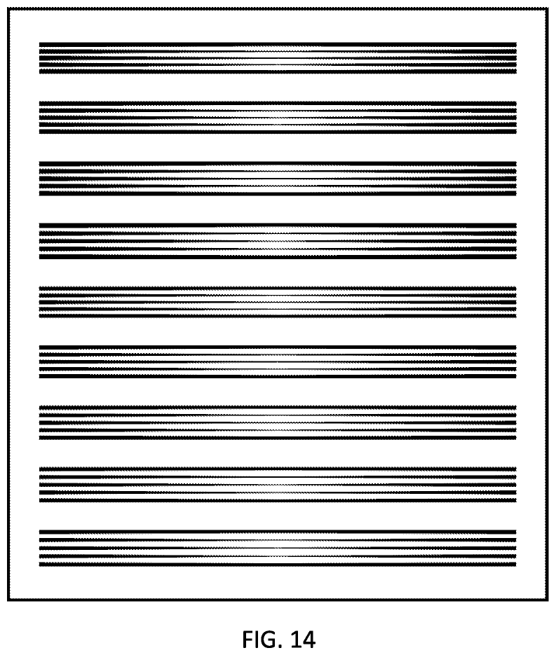

Another embodiment of a stencil is shown in FIG. 14. In this embodiment, a stencil may be sized to be comparatively close to the size of a standard sheet of paper or of a standard sheet of sheet music paper. The stencil may include multiple groupings of slot, or slot sets. In this embodiment, the stencil includes nine slot sets, though it should be understood that a single stencil may include fewer slots sets or more slot sets without deviating from the scope or intent of this disclosure. Each slot set may include the same number of slots as all of the other slot sets, or different slot sets may have different numbers of slots. Similarly, each slot set may have the same width or length slots as each other slot sets, or the widths and/or lengths of slots may vary between different groupings of slots. Though the slot sets are shown as being stacked in parallel, with one slot set directly above or below the other slot sets, slot sets may alternatively be next to one or more other slot sets, may be offset at least partially to the side relative to other slot sets, or there may be a combination of arrangements, such as two or more shorter slot sets being side by side, while also being above or below one or more other slot sets. One or more shorter slot sets may also be next to one or more longer slot sets, such as to enable the marking of a primary, long, staff with a shorter staff next to it.

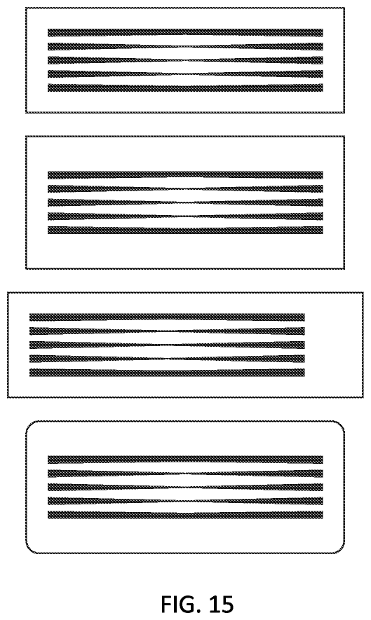

FIG. 15 shows four embodiments of the stencil with differing borders or margins relative to each other. The embodiment of the first stencil has a left margin, a right margin, a top margin, and a bottom margin which are each substantially equal in height, for the top and bottom margins, and width, for the left and right margins. The second stencil shows an embodiment where the top and bottom margins are substantially equal in height, but the left and right margins are smaller in width, though still being substantially equal to each other. The third stencil shows an embodiment where the heights of the top and bottom margins are substantially equal to each other and substantially equal to the width of the left margin, but the width of the right margin is larger width of the left margin. The fourth stencil shows margins of similar proportions to the second stencil with rounded corners. It should be understood that other arrangements of comparative sizes of the margins of the stencil may also be used, such as where the right margin is larger than the left, or the top and bottom margins are not equal in height, or the height of one or both of the top and bottom margins is less than the width of one or both of the side margins.

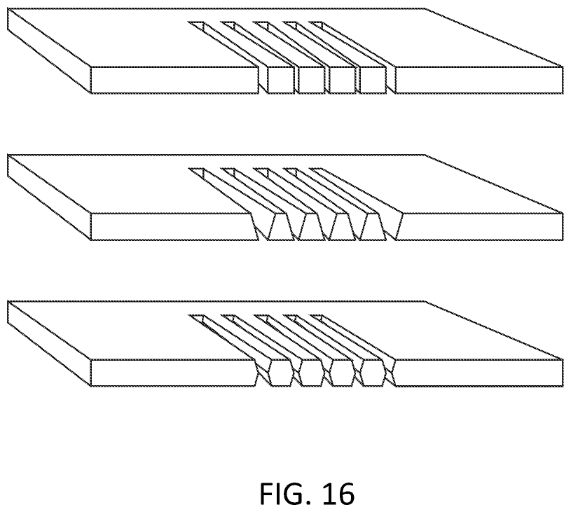

FIG. 16 shows a sectional view of the stencil, highlighting the varying possible existence of bevels along the edges of the slots. The first stencil shows a standard cut perpendicular to the surface of the stencil. The second stencil shows a one-directional bevel, in which there is one slope from the top side to the bottom side of the stencil. The third stencil shows a two-directional bevel, in which the stencil material slopes from both the top and bottom sides towards the center of the thickness of the material. These beveled options may be desirable when a variety of dip diameters need to be accommodated by one stencil. The slopes create enough space for the insertion of large tips of some marking instruments while still providing enough stability and structure for the insertion of small tips of other marking instruments.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention. Accordingly, various modifications, adaptations, combinations, and alternatives may occur to one skilled in the art without departing from the spirit of the invention and scope of the claimed coverage.

What is claimed is:

1. A stencil, comprising: a top side;
a bottom side;
a first side surface;
a first slot defined by the top side and having a first length and a first side end and a second side end;
a second slot defined by the top side and having a second length; and
a first stencil segment at least partially separating the first slot from the second slot and having a third length and defining a first midline;
wherein the first slot extends from the top side to the bottom side, the second slot extends from the top side to the bottom side, the first slot and the second slot are both configured to at least partially receive a tip of a marking instrument, a first slot side of the first slot is defined by a first stencil segment side, a second slot side of the second slot is defined by a second stencil segment side, the second slot has a third slot side, and at least one of the first slot side and the second slot side is not entirely a flat plane.

2. The stencil according to claim 1, further wherein the first stencil segment has a first width and a second width, further wherein the second width is greater than the first width.

3. The stencil according to claim 1, further wherein the first slot side further comprises a first bulge feature, the second slot side further comprises a second bulge feature, and both the first bulge feature and the second bulge feature extend away from the first midline.

4. The stencil according to claim 3, further wherein the first bulge feature and the second bulge feature are located substantially the same distance along the third length relative to the first midline.

5. The stencil according to claim 3, further wherein the second bulge feature and the first bulge feature are both a curved surface.

6. The stencil according to claim 3, further wherein at least one of the first slot side and the second slot side further comprises a flat planar surface.

7. The stencil according to claim 3, further wherein at least one of the first slot side and the second slot side has a first angled surface which is not parallel relative to the first midline.

8. The stencil according to claim 7, further wherein at least one of the first slot side and the second slot side has a second first angled surface which is not parallel relative to the first midline.

9. The stencil according to claim 3, further wherein at least one of the first slot side and the second slot side has a first planar surface which is parallel to the first midline and a first curved surface.

10. The stencil according to claim 3, further wherein the first stencil segment is at least partially made of a material which is elastically flexible.

11. The stencil according to claim 10, further wherein at least part of the second bulge feature is in contact with at least part of the third slot side when at least part of the first bugle feature is flexed towards the first midline.

12. The stencil according to claim 11, further wherein the third slot side further comprises a third bulge feature.

13. The stencil according to claim 10, further comprising a first distance between the first midline and the first side end and a second distance between the first midline and a distal point of the first bulge feature when the first stencil segment is in an unflexed configuration.

14. The stencil according to claim 13, further wherein the distal point of the first bulge feature is at a third distance relative to midline of the first stencil segment when the stencil segment is in a flexed configuration.

15. The stencil according to claim 14, further wherein the third distance is equal to the first distance when a marking instrument is passed from the first side end to the first bulge feature.

16. The stencil according to claim 15, further wherein the first slot has a top surface which is substantially parallel to the first midline.

17. The stencil according to claim 16, further wherein the second slot has a bottom surface which is substantially parallel to the first midline.

18. The stencil according to claim 15, further comprising a third slot defined by the top side, extending from the top side to the bottom side, and further wherein the third slot has a bottom surface which is substantially parallel to the first midline.

19. The stencil according to claim 18, further wherein the top side defines a first grouping of slots and the first grouping of slots comprises the first slot and the second slot.

20. The stencil according to claim 19, further wherein the top side defines a second grouping of slots.
